(19) United States
(12) Patent Application Publication
(10) Pub. No.: US 2026/0008674 A1
(43) Pub. Date: Jan. 8, 2026

(54) CONVERSION OF CARBON OXIDES TO SUSTAINABLE AVIATION FUEL (SAF)

(71) Applicant: TOPSOE A/S, Kgs. Lyngby (DK)

(72) Inventors: Sudip DE SARKAR, Kgs. Lyngby (DK); Kim AASBERG-PETERSEN, Kgs. Lyngby (DK)

(73) Assignee: TOPSOE A/S, Kgs. Lyngby (DK)

(21) Appl. No.: 18/871,580

(22) PCT Filed: Jun. 15, 2023
(86) PCT No.: PCT/EP2023/066096

§ 371 Date: Dec. 4, 2024

(30) Foreign Application Priority Data
Jun. 20, 2022 (EP) 22179912.5

(51) Int. Cl. C01B 3/38; C10G 3/00; C10G 69/12; C25B 1/04; C25B 1/23

(52) U.S. Cl. CPC C01B 3/384; C10G 3/42; C10G 69/126; C25B 1/04; C25B 1/23; C01B 2203/0233; C01B 2203/0244; C01B 2203/062; C10G 2300/1011; C10G 2400/08

(57) ABSTRACT

A reforming system is provided for dedicated steam reforming of a stream rich in paraffins and/or olefins of a jet fuel synthesis plant incorporating the reforming system. The invention provides an overall more efficient feed-to-jet fuel system and process.

### TECHNICAL FIELD

The present invention relates to a more efficient system (plant) and process for producing transportation fuels, such as synthetic kerosene e.g. jet fuel or sustainable aviation fuel (SAF), optionally also diesel, from a carbon oxide containing feed, such as from a carbon dioxide rich feed or a carbon monoxide rich feed. The plant or process comprises methanol synthesis, methanol to jet synthesis and optionally also an upgrading section. Embodiments of the invention include the provision of steam reforming in a dedicated reformer to improve overall carbon and hydrogen efficiency by feeding the reformer with a by-product stream rich in paraffins and/or olefins, optionally also an off-gas stream, which are produced in the jet fuel synthesis plant.

### BACKGROUND

Processes for the conversion of sustainable feeds, such as CO₂, biomass etc. to gasoline or jet fuel via methanol are known. Biomass can first be converted to syngas via gasification followed by conversion of said syngas to methanol, for instance in a methanol synthesis loop—hereinafter also referred to as “methanol loop”—, and finally methanol conversion to olefins. The olefins are then oligomerized and hydrogenated into jet fuel, which are hydrocarbons in the range C8-C19, such as C8-C16 or C8-C18. A CO₂ feed, together with H₂ feed, can be converted to methanol followed by conversion of said methanol to jet fuel. Irrespective of the main feed, there are some by-products along with jet fuel. One of the by-products from such processes is a fraction containing lighter hydrocarbons than the above range corresponding to jet fuel (C8-18), in particular a by-product stream rich in paraffins and/or olefins, such as light paraffins in the range C3-C7, including propane and/or butane (C3 and/or C4), as well as olefins. The C3 and/or C4 fraction is known as liquified petroleum gas, LPG. Off-gas streams comprising CO₂, H₂, CH₄, higher hydrocarbons etc. are also typically produced and withdrawn as waste gas streams.

The lighter hydrocarbons, e.g. the light paraffins, may often itself have little commercial value. Moreover, the off-gas streams often have no efficient use, apart from using them in fired equipment, which causes CO₂ emission. It would therefore be of interest to recycle these streams as part of the jet fuel synthesis process itself, in order to at least improve overall carbon efficiency (C-efficiency) of this process. Furthermore, reusing the by-product stream comprising lighter hydrocarbons, this being a stream rich in paraffins and/or olefins, hereinafter also referred to as “by-product stream rich in paraffins and/or olefins”, and/or reusing a waste stream generated in the plant or process, hereinafter also referred to as “off-gas stream” via a dedicated steam reforming into a synthesis gas stream, in e.g. a CO₂ and H₂ feed based methanol plant, enhances methanol synthesis, e.g. methanol loop, performance, as it will become apparent from one or more of the below embodiments of the invention.

EP 3730473 A1 discloses the use of renewable energy in methanol synthesis plant. Steam reforming of a number of hydrocarbon feedstocks including LPG is provided in a syngas generation section upstream methanol synthesis to provide for the methanol synthesis gas, and which is further configured such that more of the net energy required by i.a. the methanol synthesis plant, is provided by a non-carbon-based energy source, a renewable energy source, and/or electricity.

WO 2010143980 discloses a system for integrating methanol production and hydroprocessing of oil feedstock to produce a hydrocarbon product. A steam reformer processes a first feedstock and C1 to C4 hydrocarbons may be separated from the hydrocarbon product and recycled to the first feedstock. Hence, the steam reformer is provided upstream methanol synthesis to provide for the main methanol synthesis gas feed, and the hydroprocessing plant, having its own feed oil feedstock, is integrated by benefiting from the hydrogen produced in the methanol synthesis.

Applicant's co-pending European patent application No. 22166260.4 discloses the conversion of carbon dioxide to gasoline using electrical steam methane reforming (e-SMR) of a recycled liquified petroleum gas (LPG) stream.

WO2007108014 A1 discloses a process and system for producing gasoline or diesel from carbon dioxide and water. A reforming unit downstream of and in fluid communication with the gasoline or diesel generation unit is arranged to e.g. steam-reform a recycle stream having a significant portion of LPG and fuel gas, namely 15-40 wt % of the liquid product.

US20160168476 discloses a methanol-to-gasoline plant by combining the use of ZSM-5 with Y-zeolite, in which a by-product stream is withdrawn and converted to a synthesis gas in a reformer. This synthesis gas is combined with a main synthesis gas and fed to a first reactor for conversion to methanol. LPG and similar off-gases are directed away from the reformer.

A need therefore exists for an effective process and system for utilising a by-product stream rich in paraffins and/or olefins, optionally also off-gas streams, as well as hydrogen rich streams from a sustainable feed-to-jet fuel synthesis plant to improve overall C-efficiency as well as hydrogen efficiency (H-efficiency), but in which disadvantages can be avoided; in particular, in which additional CO₂ emissions are avoided, and in which there is improved methanol loop performance including a smaller methanol loop.

### SUMMARY

The addition of reformed syngas from a by-product stream rich in paraffins and/or olefins, optionally also from an off-gas stream, to e.g. a H₂ and CO₂ based methanol synthesis e.g. in a methanol loop (MeOH loop), ensures a CO/CO₂ molar ratio in the inlet thereto that reduces the formation of water—a precursor of methanol catalyst sintering—, and that results in lower methanol synthesis catalyst volume in the methanol synthesis reactor for same production and thereby, a smaller methanol synthesis unit, smaller e.g. MeOH loop, as it will become apparent from the description below.

A jet fuel synthesis plant is therefore provided which comprises:
a first CO₂ rich feed comprising CO₂ to said plant, a first H₂ rich feed comprising H₂ to said plant, or a first syngas feed combining these streams; or a second syngas feed comprising a carbon oxide and hydrogen to said plant;
a methanol synthesis unit;
a methanol-to-jet fuel (MTJ) synthesis section comprising oxygenate-to-olefins conversion (MTO) such as methanol-to-olefins conversion, oligomerization (OLI) of at least a portion of the olefins to provide an oligomerised raw product stream, and hydrogenation (HYDRO) of at least a portion of the oligomerised raw product stream to provide a raw product containing hydrocarbons boiling in the jet fuel range;
optionally, an upgrading section, which comprises: a hydrocracking (HCR) reactor and/or a fractionation unit—the jet fuel synthesis plant further comprises a reforming system for reforming a by-product stream rich in paraffins and/or olefins, optionally also an off-gas stream, from the MTJ synthesis section and/or from the upgrading section, to provide a reformer-based syngas stream;—and the jet fuel synthesis plant further being arranged to feed at least a portion of said reformer-based syngas stream to the inlet of the methanol synthesis unit.

Also provided is a process for jet fuel synthesis from a sustainable feed, in such a plant.

Further details of the technology are provided in the enclosed dependent claims and figures.

### LEGENDS TO THE FIGURES

The technology is illustrated by means of the following schematic illustrations, in which:

FIG. 1 shows an embodiment of the reforming system of the invention.

FIG. 2 shows an embodiment of a jet fuel plant, comprising an embodiment of the reforming system of the invention.

FIG. 3 shows another embodiment a jet fuel synthesis plant, comprising the reforming system of the invention.

FIG. 4 shows an embodiment of the jet fuel synthesis plant, further comprising the provision of excess hydrogen from the methanol synthesis unit being fed to the reforming system.

### DETAILED DISCLOSURE

Unless otherwise specified, any given percentages for gas content are % by volume. All feeds are preheated as required.

The term “synthesis gas” (abbreviated to “syngas”) is meant to denote a gas comprising hydrogen and a carbon oxide, and optionally small amounts of other gasses, such as argon, nitrogen, methane, etc.

The term “a carbon oxide” means CO and/or CO₂.

The term “first syngas feed” means a syngas rich in H₂ and CO₂ resulting from the combination of the first H₂ rich stream and the first CO₂ stream. For instance, the first syngas feed contains about 75 H₂% and about 25% CO₂ with less than 1% CO.

The term “second syngas feed” means a separate syngas feed produced upstream the methanol synthesis unit of the jet fuel synthesis plant. For instance, the second syngas feed comprises H₂ and the carbon oxide(s) in a molar ratio of at least 3:1.

A “sustainable feed” may be a CO₂ feed, a H₂ feed, or combination thereof; or a biomass feed, or a syngas feed produced at least partly from electrolysis.

The term “first, second or third or fourth syngas stream”, are also referred to as a “reformer-based syngas stream” and means a syngas stream withdrawn from a dedicated reforming system comprising the reforming unit (reformer) for treating the e.g. by-product stream rich in paraffins and/or olefins. For instance, where the reformer is an e-SMR the reformer-based syngas stream is an e-SMR based syngas stream.

The term “reforming” and “steam reforming” are used interchangeably.

The term “at least a portion” of a given stream, means the entire stream or a portion thereof.

The term “MTO” means methanol to olefin conversion, or oxygenate to olefin conversion.

The oxygenate comprises methanol and/or dimethyl ether (DME).

The term “OLI” means oligomerization of olefins.

The term “HYDRO” means hydrogenation of oligomerized olefins.

The term “MTJ section” means methanol to jet fuel section, or oxygenate to fuel jet section. The oxygenate comprises methanol and/or dimethyl ether (DME). The MTJ section comprises a MTO reactor, OLI reactor and HYRO reactor.

The terms “system”, “plant” i.e. process plant, are used interchangeably. Throughout this specification, the term system is used for the reforming, hence the term “reforming system”.

The terms “section” and “unit” refers normally in this specification to a subset of a plant or system.

The use of the article “a” or “an” in connection with an item such as a unit means “one or more”. For instance, the term “an electrical heated steam methane reformer (e-SMR)” means one or more, such as a plurality of e-SMRs arranged in parallel. For instance, the term “a fractionation unit” means one or more fractionation units.

The term “suitably” may be given the same meaning as “optionally”, i.e. an optional embodiment.

Other definitions are provided throughout the patent application in connection with the recital of embodiments.

The jet fuel synthesis plant therefore comprises, in general terms:
a first CO₂ rich feed to said plant, a first H₂ rich feed to said plant, or a first syngas feed combining these streams, or
a second syngas feed comprising a carbon oxide and hydrogen to said plant;
   and
a methanol synthesis unit with no upstream steam reforming unit to provide the syngas feed;
a MTJ synthesis section;
optionally, an upgrading section which comprises: a hydrocracking (HCR) reactor and/or a fractionation unit; and
a reforming system comprising a reforming unit (reformer).

The jet fuel synthesis plant does not comprise a reforming unit for the steam reforming of a hydrocarbon feed gas which is arranged upstream the methanol synthesis unit for providing said first or second syngas feed.

Now more specifically, in a first embodiment, a jet fuel synthesis plant is provided, which comprises:
a first CO₂ rich feed (201) comprising CO₂ to said plant, a first H₂ rich feed 202 comprising H₂ to said plant, or a first syngas feed (209) combining the first CO₂ rich feed (201) and the first H₂ rich feed 202; or a second syngas feed 205 comprising a carbon oxide and hydrogen to said plant;
a methanol synthesis unit 220, arranged to receive the first CO₂ rich feed 201 and the first H₂ rich feed 202, or arranged to receive the first syngas feed 209, or arranged to receive the second syngas feed 205, and provide an effluent stream 221 comprising methanol;
a methanol-to-jet fuel (MTJ) synthesis section 230, arranged to receive at least a portion of the effluent stream 221 comprising methanol, and provide a raw product 231 containing hydrocarbons boiling in the jet fuel range;
optionally, an upgrading section 240, arranged to receive at least a portion of the raw product 231 from the MTJ synthesis section 230, and provide a jet fuel product stream 241; said optional upgrading section 240 comprising: a hydrocracking (HCR) reactor and/or a fractionation unit, thereby providing said jet fuel product stream 241;
said MTJ synthesis section 230 and/or said upgrading section 240 being arranged to provide a by-product stream 242, 242′ rich in paraffins and/or olefins;
said jet fuel synthesis plant 200 further comprising a reforming system 100 for reforming said first by-product stream 242, 242′ rich in paraffins and/or olefins, said reforming system 100 comprising: a first reforming feed stream 1 as said by-product stream 242, 242′ rich in paraffins; a reforming unit (reformer, 40) arranged to receive the by-product stream 1, 242, 242′ rich in paraffins and/or olefins, and carry out a steam reforming step, and provide a reformer-based syngas stream 41, 51, 53, 62;
said jet fuel synthesis plant (200) further being arranged to feed at least a portion of said reformer-based syngas stream, to the inlet of the methanol synthesis unit 220;
said jet fuel synthesis plant 200 does not comprise a reforming unit arranged upstream the methanol synthesis unit 220 for providing said first 209 or second 205 syngas feed.

A much simpler plant with significantly lower carbon footprint is thereby provided, since the reforming is only conducted for a minor internal reforming feed stream, namely the by-product stream rich in paraffins, optionally also an off-gas stream. Furthermore, the reformed-based syngas to methanol synthesis unit (e.g. MeOH loop) ensures a CO/CO₂ molar ratio needed for lower catalyst volume and thereby, smaller methanol synthesis unit, e.g. smaller MeOH loop.

In an embodiment, the reformer-based syngas stream is a first, second or third reformer-based syngas stream 41, 51, 53.

In an embodiment, the reformer (40) in the reforming system 100 is any of a: steam methane reformer (SMR) i.e. tubular reformer, electrical steam methane reformer (e-SMR), autothermal reformer (ATR), convection heated reformer such as a heat exchange reformer (HER), and combinations thereof.

Hence, in the reforming system receiving the by-product stream rich in paraffins and/or olefins, a primary reformer such as an SMR may be arranged together with e.g. an ATR; or a convection heated reformer (convection reformer) such as a heat exchange reformer (HER) may be arranged together with an ATR. For instance also, an ATR and e-SMR, see farther below, may be arranged together. The arrangement may be in series or in parallel.

In an embodiment, the reformer is e-SMR alone or in combination with ATR, optionally arranged alone or together with upstream pre-reformer, and said reformer is arranged to receive said first reforming feed stream as said by-product stream rich in paraffins, and provide a one product stream in the form of said reformer-based syngas stream.

Hence, the outlet of the reforming system is a one product stream in the form of said reformer-based syngas stream, which comprises CO.

A reformer-based syngas stream comprising CO is advantageous for the methanol synthesis. As mentioned above, the addition of syngas via reforming of said first reforming feed stream increases the CO content in the syngas to the methanol synthesis unit. This is advantageous for improving the performance of the methanol synthesis unit, for instance where this unit is provided as a methanol synthesis loop, i.e. smaller MeOH loop compared to when main feed to the methanol synthesis unit is H₂ and CO₂.

The convection reformer may for instance comprise one or more bayonet reforming tubes such as an HTCR reformer i.e. Topsoe bayonet reformer, where the heat for reforming is transferred by convection along with radiation. In a steam methane reformer (SMR) i.e. a tubular reformer, the heat for reforming is transferred chiefly by radiation in a radiant furnace. In an autothermal reformer (ATR), there is partial oxidation of the hydrocarbon feed with oxygen and steam followed by catalytic reforming. In an electrically heated steam methane reformer (e-SMR), electrical resistance is used for generating the heat for catalytic reforming.

For more information on these reformers, details are herein provided by direct reference to applicant's patents and/or literature. For instance, for tubular and autothermal reforming an overview is presented in “Tubular reforming and autothermal reforming of natural gas—an overview of available processes”, Ib Dybkjær, Fuel Processing Technology 42 (1995) 85-107; and EP 0535505 for a description of HTCR. For a description of ATR, see farther below. For a description of e-SMR which is a more recent technology, reference is given to in particular WO 2019/228797 A1.

In an embodiment, the catalyst in the steam reforming unit is a reforming catalyst, e.g. a nickel based catalyst. In an embodiment, the is active for water gas shift reactions. Examples of reforming catalysts are Ni/MgAl₂O₄, Ni/Al₂O₃, Ni/CaAl₂O₄, Ru/MgAl₂O₄, Rh/MgAl₂O₄, Ir/MgAl₂O₄, Mo₂C, Wo₂C, CeO₂, Ni/ZrO₂, Ni/MgAl₂O₃, Ni/CaAl₂O₃, Ru/MgAl₂O₃, or Rh/MgAl₂O₃, a noble metal on an Al₂O₃ carrier, but other catalysts suitable for reforming are also conceivable. The catalytically active material may be Ni, Ru, Rh, Ir, or a combination thereof, while the ceramic coating may be Al₂O₃, ZrO₂, MgAl₂O₃, CaAl₂O₃, or a combination therefore and potentially mixed with oxides of Y, Ti, La, or Ce. The maximum temperature of the reactor may be between 850-1300° C. The pressure of the feed gas may be 15-180 bar, preferably about 25 bar. Steam reforming catalyst is also denoted steam methane reforming catalyst or methane reforming catalyst.

In another embodiment, the reformer (40) in the reforming system 100 is:
an electrical steam methane reformer (e-SMR), which is arranged alone or together with an upstream pre-reformer;
   or
an autothermal reformer (ATR), which is arranged alone or together with an upstream pre-reformer.

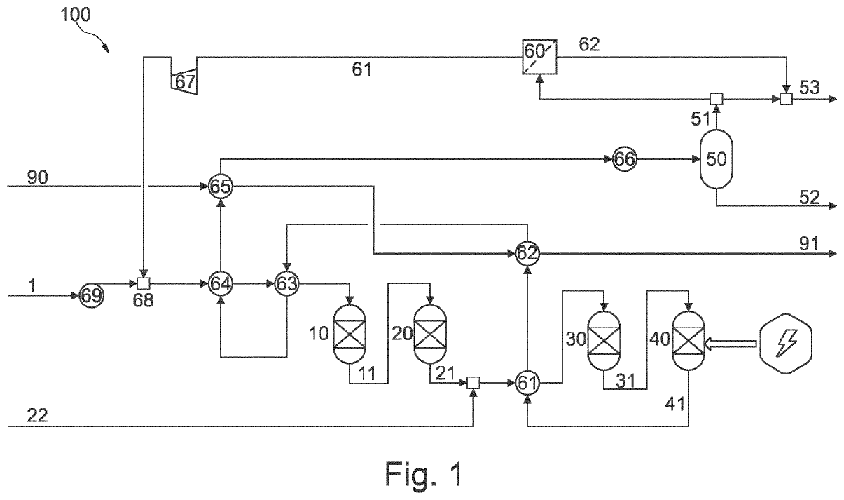

Hence, there is for instance no primary reformer arranged together with the e-SMR in the reforming system), such as a steam methane reformer (SMR) arranged upstream the e-SMR, or a convection heated reformer such as a heat exchange reformer arranged in series or in parallel with the e-SMR. Yet, a pre-reformer (pre-reforming unit) is suitably arranged upstream the e-SMR. Thus, the e-SMR is arranged alone or together with an upstream pre-reformer. Such an arrangement is also referred to stand-alone e-SMR. See appended FIG. 1.

Likewise, there is for instance no primary reformer arranged together with the ATR in the reforming system), such as a steam methane reformer (SMR) arranged upstream the e-ATR, or a convection heated reformer such as a heat exchange reformer arranged in series or in parallel with the ATR. Yet, a pre-reformer (pre-reforming unit) is suitably arranged upstream the ATR. Thus, the ATR is arranged alone or together with an upstream pre-reformer. Such an arrangement is also referred to stand-alone ATR.

An even simpler plant with only a single reformer, optionally including a pre-reformer, is thereby obtained, as so is an even lower carbon footprint particularly where the reformer is an e-SMR, as this can be powered by electricity from renewable sources such as wind, solar, hydro, geothermal, or for instance also, thermonuclear. For the purposes of the present application, the latter source is regarded as renewable.

It has been determined that the by-product stream rich in paraffins and/or olefins, optionally an off-gas stream which is recycled, can be enabled to provide higher efficiency of sustainable feed to jet fuel conversion. With the proposed plant layout, this can be achieved with no or significantly lower CO₂ emission compared to traditional processes for a similar purpose. Furthermore, the proposed layout also has provided a possibility of reducing the consumption of hydrogen feedstock, thereby increasing hydrogen-efficiency. The production of hydrogen is power consuming and capital cost intensive, e.g. when using an electrolysis unit for producing the hydrogen. Thus, where electrolysis for producing hydrogen is omitted, the reduction of power consumption in the electrolysis unit more than outweighs the power consumption in the e-SMR resulting in a reduction of power consumption for the overall system. The outlet of the e-SMR is a one product stream, i.e. a one syngas stream, which is implicit in an e-SMR. The one syngas stream is for instance first syngas stream 41 of appended FIG. 1.

Further details on e-SMR and ATR are presented below:

In the reforming system, the reforming unit is, in an embodiment, an electrical steam methane reformer (e-SMR). The e-SMR is thus arranged to receive the first reforming feed stream and carry out an electrical steam methane reforming (e-SMR) step, to provide an e-SMR based syngas stream.

Use of an e-SMR in this manner allows recycling of the by-product stream rich in paraffins and/or olefins, optionally the off-gas streams, such that additional CO₂ emissions can be avoided, or significantly minimised.

The e-SMR requires a feed of steam. The e-SMR receives the first reforming feed stream and carries out an electrical steam methane reforming (e-SMR) step, and thereby provides a first syngas stream. e-SMRs use electrical resistance heating to provide sufficient heating of the reactant stream and catalyst for effective reforming reaction to be carried out. The e-SMR preferably comprises a pressure shell housing a structured catalyst, wherein the structured catalyst comprises a macroscopic structure of an electrically conductive material. The macroscopic structure supports a ceramic coating, where said ceramic coating supports a catalytically active material. The reforming step comprises the step of supplying electrical power via electrical conductors connecting an electrical power supply placed outside said pressure shell to said structured catalyst, allowing an electrical current to run through said macroscopic structure material, thereby heating at least part of the structured catalyst to a temperature of at least 500° C.

Suitably, the electrical power supplied to the e-SMR is generated by means of a renewable energy source. Suitable e-SMR for use in reforming system of the present invention are as disclosed in co-pending applications WO2019/228797 and WO2019/228798.

In a steam reforming process, a stream of hydrocarbons and steam is catalytically reformed to a product stream of hydrogen and carbon oxides; typified by the following reactions:

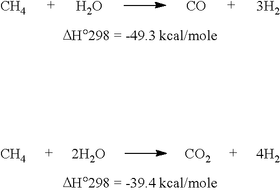

The water gas shift (WGS) reaction may also take place:

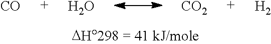

The reactions are in equilibrium at reactor outlet conditions.

In the reforming system, the reforming unit is, in another embodiment, an ATR. The ATR is thus arranged to receive the first reforming feed stream along with the oxidant stream which includes oxygen from an electrolysis unit, and carry out an autothermal reforming step, to provide e.g. said first ATR-based syngas stream.

Also use of an ATR in this manner allows recycling of e.g. the by-product stream rich in paraffins and/or olefins, optionally off-gas streams, such that additional CO₂ emissions can be avoided, or significantly minimised.

The main elements of an ATR reactor are a burner, a combustion chamber, and a catalyst bed contained within a refractory lined pressure shell. In an ATR reactor, partial oxidation or combustion of a hydrocarbon feed by sub-stoichiometric amounts of oxygen is followed by steam reforming of the partially combusted hydrocarbon feed stream in a fixed bed of steam reforming catalyst. Steam reforming also takes place to some extent in the combustion chamber due to the high temperature. The steam reforming reaction is accompanied by the water gas shift reaction. Typically, the gas is at or close to equilibrium at the outlet of the ATR reactor with respect to steam reforming and water gas shift reactions. The temperature of the exit gas is typically in the range between 85° and 1100° C. More details of ATR and a full description can be found in the art such as “Studies in Surface Science and Catalysis, Vol. 152,” Synthesis gas production for FT synthesis “; Chapter 4, p.258-352, 2004”.

Suitable process conditions (temperatures, pressures, flow rates etc.) and suitable catalysts for such steam reforming processes are known in the art.

The jet fuel synthesis plant does not comprise steam reforming for preparing the first or second syngas feed. Optionally, however, the jet fuel synthesis plant may be provided with a reverse water gas shift unit (rWGS unit) arranged upstream the methanol synthesis unit for preparing said second syngas feed, as it also will become apparent from a below embodiment.

Traditionally, steam reforming of a major hydrocarbon feed gas, such as natural gas, is required upstream the methanol synthesis unit for providing a methanol synthesis gas as the syngas feed. The steam reforming unit is typically highly costly in terms of capital and operating expenses, and not least also with a significant carbon footprint. The present application obviates this and instead integrates a reforming system including a reformer which is only dedicated to steam reform a minor hydrocarbon stream, namely the by-product stream rich in paraffins and/or olefins from the MTJ synthesis section or upgrading section of the plant, as well as optional off-gas streams. The sum of these streams still represents a minor stream being fed to the reforming system. For instance, up to 50% (vol. basis), such as 5-45%, is from the reformer-based syngas stream of the reforming system of the jet fuel synthesis plant, as it will also become apparent from a below embodiment. Apart from the benefits associated with enabling a smaller methanol synthesis unit e.g. methanol loop, a much smaller reformer is thus required, thereby reducing plant plot size and associated capital and operating expenses. Further, by for instance utilizing electrical steam reforming (e-SMR), the unit can be made even more compact and importantly, carbon emission is drastically reduced, as the electrical heating may be powered by renewable sources, such as wind, solar or hydropower.

In an embodiment, said reforming system 100 is further arranged for said first reforming feed 1, 242, 242′ being less than 15 wt % of said raw product 231 containing hydrocarbons boiling in the jet fuel range, or less than 15 wt % of said jet fuel product stream 241.

The by-product formation and off-gas formation, thus light hydrocarbons streams in the jet fuel synthesis plant, represent less than 15 wt %, such as 10 wt % or less, for instance 5 wt % of the jet fuel being produced, this being the raw product containing hydrocarbons boiling in the jet fuel range, or the jet fuel product stream. Despite the by-product and off-gas(es) only representing less than 15 wt % or less, e.g. about 10 wt %, or 5 wt %, of the hydrocarbon product, these are advantageously reused in the plant or process to increase its overall efficiency: carbon (C-efficiency) and hydrogen efficiency (H-efficiency), instead of directing these streams away for use as fuel gas. Despite the low percentage of e.g. the by-product and off-gas, thus e.g. said first reforming feed 1, 242, 242′, a dedicated reforming unit for reforming such by-product and off-gas into a syngas, is advantageously provided, instead of utilizing these streams as said fuel gas.

More generally, the associated improvement in C-efficiency or overall plant/process efficiency is not merely equivalent to the percentage of said by-product and/or off-gas streams with respect of hydrocarbon product, but higher; this being regardless of the percentage of e.g. LPG and/or off-gases being recycled with respect to hydrocarbon product, such as 10, 20, 30% or 40% of the hydrocarbon product (jet fuel) being produced. For instance, where the formation of the by-product and/or off-gas streams fed to the reforming system in the jet fuel synthesis plant represents 10 wt %, the increase in overall plant/process efficiency is not merely 10%, but higher than 10%, when an e-SMR is provided. In the e-SMR of the reforming system all carbon being fed is utilized for producing syngas, thereby providing CO into the inlet of the methanol synthesis unit, instead of the reforming system requiring the use of at least part of the gas, e.g. LPG, for burning purposes, thus as fuel gas, as it is conventional when operating with other type of reformers, such as autothermal reformers. Hence, not only is there an associated benefit of the provision of e-SMR in terms of drastically reducing or eliminating the carbon intensity of the plant by the e-SMR not emitting CO₂, but also C-efficiency and H-efficiency are increased, and not least methanol synthesis performance, e.g. MeOH loop performance is improved thus enabling a smaller methanol synthesis unit, as CO in the syngas from the reforming system is fed to the methanol synthesis.

The first CO₂ rich feed is provided to the methanol synthesis unit (as mentioned before, this suitably being a methanol synthesis loop, or simply methanol loop, i.e. MeOH loop). In a particular embodiment, the first CO₂ rich feed comprises more than 75% CO₂, such as more than 90% CO₂, for instance more than 95% CO₂, or more than 99% CO₂. The first CO₂ rich feed may in addition to CO₂ comprise minor amounts of, for example, steam, oxygen, nitrogen, oxygenates, amines, ammonia, carbon monoxide, and/or hydrocarbons. The first CO₂ rich feed suitably comprises only low amounts of hydrocarbon, such as for example less than 5% hydrocarbons or less than 3% hydrocarbons or less than 1% hydrocarbons.

The first H₂ rich feed is provided to the methanol synthesis unit. Suitably, the first H₂ rich feed consists essentially of hydrogen. The first H₂ rich feed of hydrogen is suitably “hydrogen rich” meaning that the major portion of this feed is hydrogen; i.e. over 75%, such as over 85%, preferably over 90%, more preferably over 95%, even more preferably over 99% of this feed is hydrogen.

One source of the first H₂ rich feed of hydrogen can be one or more electrolyser units.

Accordingly, in an embodiment, the jet fuel synthesis plant further comprises:
an electrolysis section comprising:
   an electrolysis unit 260 arranged to receive a water feedstock 203, i.e. steam and/or water, and provide a second H₂ rich feed 202′ comprising H₂; optionally as said first H₂ rich feed 202 comprising H₂, or a portion thereof as said first H₂ rich feed 202; and/or,
   an electrolysis unit 250 arranged to receive a second first CO₂ rich feed 201′, or said first CO₂ rich feed 201 comprising CO₂, or a portion thereof, and provide a CO-enriched feed 204;
   means such as a mixing unit or junction (i.e. juncture) to combine the first or second H₂ rich feed 202′ comprising H₂ with the CO-enriched feed 204, and provide said second syngas feed 205.

In an embodiment, the reformer in the reforming system comprises an ATR, such as a stand-alone ATR, the electrolysis unit arranged to receive a water feedstock provides a first oxygen stream 206, and the jet fuel synthesis plant further comprises: means such as a mixing unit or junction to combine a steam stream 207 with the first oxygen stream 206 to provide an oxidant stream (208); and the ATR is arranged to receive said oxidant stream.

Suitably also, the electrolysis unit arranged to receive a second CO₂ rich feed 201′, or said first CO₂ rich feed 201 comprising CO₂, or a portion thereof, provides a second oxygen stream 206′, and the jet fuel synthesis plant further comprises: means such as mixing unit or junction to combine the first 206 and/or second 206′ oxygen streams, with said steam stream 207, to provide the oxidant stream 208.

Thereby there is provided a high integration of process streams in the jet fuel synthesis plant, while at the same time eliminating the need of providing a large and expensive air separation unit (ASU), typically required for the generation of the oxygen needed when the reformer is an ATR.

Suitably also, a portion of the second CO₂ rich feed 201′, or a portion of the first CO rich feed 201, may bypass the electrolysis unit 250 and combine with the CO-enriched feed stream 204. Some CO₂ is required in the syngas feed, here the second syngas feed, so the by-pass enables adjusting the syngas feed module and CO₂ content for optimum performance of the methanol synthesis unit. In a particular embodiment, up to 10% of the first or second CO₂-rich feed bypasses the electrolysis unit.

In addition to hydrogen, the first or second H₂-rich feed may for example comprise steam, nitrogen, argon, carbon monoxide, carbon dioxide, and/or hydrocarbons. In some cases, a minor content of oxygen may be present in this first or second H₂ rich feed, typically less than 100 ppm. The first or second H₂ rich feed suitably comprises only low amounts of hydrocarbon, such as for example less than 5% hydrocarbons or less than 3% hydrocarbons or less than 1% hydrocarbons.

Suitably, there is also provided a purification section to remove impurities such as oxygen and hydrocarbons from the first or second H₂ rich feed. Suitably also, there is a purification section to remove impurities such as sulfur containing compounds e.g. COS, from e.g. the first CO₂ rich feed.

The first CO₂ rich feed and the first H₂ rich feed are—in one aspect—combined into said first syngas feed prior to being fed to the methanol synthesis unit.

In this embodiment, the jet fuel synthesis plant comprises a methanol synthesis unit, being arranged to receive the first CO₂ rich feed and first H₂ rich feed, or the first syngas feed which combines the first CO₂ rich feed and first H₂ rich feed, as well as the reformer-based syngas from the reforming system, suitably the second reformer-based syngas therefrom. An effluent stream comprising methanol is obtained. The process of converting the first CO₂ rich and first H₂ rich streams can occur, for example by compressing them in a first syngas feed compressor and sending the compressed, combined gas as first syngas feed through e.g. a boiling water methanol reactor as one embodiment of a methanol reactor in the methanol synthesis unit, and where at least a portion of the CO, CO₂ and H₂ is converted to methanol followed by a condensation section separating the purge gas stream from the methanol in a liquid phase.

The raw methanol stream (i.e., the effluent stream comprising methanol) comprises a major portion of methanol; i.e. over 50 wt %, such as over 75 wt %, preferably over 85 wt %, more preferably over 90 wt % of this feed is methanol. Other minor components of this stream include but not limited to, higher alcohols, ketones, aldehydes, DME, organic acids and dissolved gases. The raw methanol comprises also water, which normally requires removal e.g. by distillation in order to purify the stream into a stream comprising more than 90% wt methanol. For instance, raw methanol from pure H₂ and CO₂ would comprise about 50 wt % water. Hence, a water separation section is suitably located between the methanol synthesis unit (220) and the gasoline synthesis section (230), and being arranged to remove water from the effluent stream (221) comprising methanol.

A second syngas feed comprising a carbon oxide and hydrogen may thus also be provided to the methanol synthesis unit. This second syngas feed is suitably provided by combining the second H₂ rich feed and the CO-enriched feed generated in the electrolysis section.

This also ensures a higher molar ratio CO/CO₂ to the methanol synthesis unit which is superior than providing a CO₂-rich feed, by enabling a lower catalyst volume, less water formation and thus less need for purification downstream to remove it, and thereby also a smaller methanol synthesis unit, e.g. smaller MeOH loop. More specifically, the provision of much higher content of CO with respect of CO₂ in the syngas feed, with the molar ratio CO/CO₂ being greater than 1, such as greater than 2, for instance a ratio of 10 or higher, means a more reactive syngas, since it enables that the methanol reaction proceeds with low generation of water which is detrimental for the methanol synthesis catalyst in the subsequent methanol synthesis unit, as the methanol synthesis is conducted mainly according to the reaction: CO+2H₂=CH₃OH, rather than typically via the reaction 3H₂+CO₂=CH₃OH+H₂O. Less hydrogen consumption, by a drastic decrease now requiring 2 moles of H₂ instead of 3 moles of H₂ for each mole of produced methanol, is also achieved. The resulting water has also a negative effect on the performance of the methanol synthesis catalyst and the catalyst volume may increase with more than 100% if the CO₂ concentration in the syngas feed is too high, e.g. 90%.

Much more energy is also required for the downstream purification of the methanol because all the water is removed by distillation. Not least, there is an increase in the output of methanol being produced, which manifests itself in a higher yield of the desired jet fuel product.

In an embodiment, the jet fuel synthesis plant further comprises:
a thermal decomposition unit, such as a gasification unit, arranged to receive a biomass feedstock to provide a crude syngas feed, and a crude syngas purification section arranged to receive the crude syngas feed and to provide said second syngas feed 205.

Suitably, at least a portion of the first and/or second oxygen streams from the electrolysis section, is provided to the thermal gasification unit, such as gasification unit.

The thermal decomposition unit is not a primary reforming unit. It would be understood that the latter, e.g. SMR (tubular reformer), or a convection heated reformer such as a heat exchange reformer, comprises a catalyst arranged as a fixed bed for converting a hydrocarbon feed gas into syngas.

Typically, where there is a gasification for producing a syngas feed for downstream methanol production, the syngas feed is subjected to a shifting step i.e. water gas shift step (WGS step) in a WGS section for changing the composition of the syngas according to the reaction CO+H₂O=CO₂+H₂. The WGS may either be sweet (without sulfur in the syngas) our sour (including sulfur in the syngas). Finally, some of the CO₂ is removed in a CO₂ removal section, which is a highly large unit with concomitant high capital and operating expenses. Further, this results in venting CO₂ from the process. For adjusting of the module M=(H₂−CO₂)/(CO+CO₂) of the syngas feed to the desired level of about 2.0 for the downstream methanol synthesis, typically part of the syngas bypasses the WGS step and the CO₂ removal.

By the present invention, the second syngas feed may be combined with reformer-based syngas stream, e.g. the first, second or third reformer-based syngas stream of the reforming system, to adjust the feed to the methanol synthesis unit. The need of a WGS section and CO₂-removal section on the second syngas feed may thus be eliminated.

The term “thermal decomposition” means any decomposition process, in which a material is partially decomposed at elevated temperature, typically 250° C. to 800° C. or perhaps 1000° C., in the presence of sub-stoichiometric amount of oxygen (including no oxygen). The product will typically be a combined liquid and gaseous stream, as well as an amount of solid char. The term shall be construed to included processes known as gasification, pyrolysis, partial combustion, or hydrothermal liquefaction.

In a particular embodiment, the thermal decomposition is gasification. Thus, the thermal decomposition unit is a gasification unit. The gasification is suitably conducted under the presence of a gasification agent such as oxygen, steam, carbon dioxide, or a combination thereof. Suitably also, the gasification agent is produced in the process; for instance, oxygen is provided by electrolysis and steam from the methanol conversion step in the methanol synthesis unit.

In the crude syngas purification section, under the addition of e.g. water, impurities such as heavy metals, silica, sulfur, which may be detrimental for downstream units and corresponding process steps are removed.

The term “biomass feedstock” means renewable feed, in particular a solid renewable feed. The solid renewable feed is:
a lignocellulosic biomass including: wood products, forestry waste, and agricultural residue; and/or
refused derived fuel (RDF) including municipal waste, i.e. municipal solid waste, in particular the organic portion thereof.

The term “lignocellulosic biomass” means a biomass containing, cellulose, hemicellulose and optionally also lignin. The lignin or a significant portion thereof may have been removed, for instance by a prior bleaching step. The lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

The term “refused derived fuel (RDF)” means a fuel produced from various types of waste, such as municipal solid waste (MSW), industrial waste or commercial waste. In accordance with the definition provided by Wikipedia.org as of 25 Apr. 2022, RDF consists largely of combustible components of such waste, as non-recyclable plastics (not including PVC), paper cardboard, labels, and other corrugated materials. These fractions are separated by different processing steps, such as screening, air classification, ballistic separation, separation of ferrous and non-ferrous materials, glass, stones and other foreign materials and shredding into a uniform grain size, or also pelletized in order to produce a homogeneous material which can be used as substitute for fossil fuels in e.g. cement plants, lime plants, coal fired power plants or as reduction agent in steel furnaces.

The term “municipal solid waste (MSW)” means trash or garbage thrown away as everyday items from homes, school, hospitals and business. Municipal solid waste includes packaging, newspapers, clothing, appliances, and food rests. For the purposes of the present application the term “municipal solid waste” may be defined as a feedstock containing materials of items discarded by the public, such as mixed municipal waste given the waste code 200301 in the European Waste Catalog (EWC code 20 03 01).

The second syngas feed is rich in CO, for instance (by mole or volume, dry basis): 40-70% such as 60% CO, 1-10% CO₂ such as 5%, 20-40% H₂ such as 30% H₂, the balance being inerts: N₂+Ar, and H₂S. The high molar ratio of CO/CO₂ in the second syngas feed thus provides the same benefits of having a high CO/CO₂ molar ratio recited above.

The reformer-based syngas generated by reforming the stream rich in paraffins and/or olefins contains CO, CO₂ and H₂, has a composition which also ensures a CO/CO₂ molar ratio, needed for lower methanol catalyst volume and thereby, smaller methanol synthesis unit, e.g. smaller MeOH loop. For instance, the composition of a first e-SMR syngas stream, which is the syngas withdrawn from an e-SMR in the reforming system, is (by volume, dry basis): 40-70% H₂, 10-30% CO, 2-20% CO₂, 0.5-5% CH₄.

To obtain an optimized yield in the methanol production, the stoichiometry of H₂, CO and CO₂ needs to be considered. Hence, in an embodiment, the first or second syngas feed has a molar ratio CO/CO₂ greater than 1, such as greater than 2, e.g. 10 or higher. Suitably also, the first or second syngas feed has a module M=(H₂−CO₂)/(CO+CO₂) defined in terms of molar content, in the range 1.80-2.20, such as 1.95-2.10. Similarly, the reformed-based syngas, e.g. the first and second reformer-based syngas streams, may have a molar ratio CO/CO₂ greater than 2, such as 10 or higher. Suitably also, the reformer-based syngas has a module M=(H₂−CO₂)/(CO+CO₂) in the range 1.80-2.40, such as 1.95-2.10.

In an embodiment, the jet fuel synthesis plant (200) comprises:
a reverse water gas shift (rWGS) unit, preferably an electrical rWGS unit (e-rWGS) unit, arranged to receive a portion of said first CO₂ rich feed 201 comprising CO₂ and a portion of said first H₂ rich feed 202 comprising H₂, to provide a rWGS syngas feed; and means such as a mixing unit or junction to combine the rWGS syngas feed with the remaining portion of: said first CO₂ rich feed 201 comprising CO₂ and said first H₂ rich feed 202 comprising H₂, and provide said second syngas feed (205). In a particular embodiment, the rWGS is also arranged to receive a portion of said by-product stream 242, 242′ rich in paraffins and/or olefins.

The rWGS reaction CO₂+H₂=CO+H₂O is endothermic, requiring a significant heat input. The rWGS unit is thus preferably electrically heated (e-rWGS unit). In that case, optionally a portion of the by-product stream rich in paraffins and/or olefins, optionally also a portion of the off-gas stream is sent to the e-rWGS unit, since the e-rWGS unit may also enable some steam reforming of these streams.

For details on e-rWGS, reference is given to e.g. applicant's WO 2022079098 (e-RWGS section therein).

The first or second syngas feed as well as the reformer-based syngas may be combined and fed to the methanol synthesis unit.

Accordingly, in an embodiment, the at least a portion of said reformer-based syngas stream 41, 51, 53, 62, such said first, second or third syngas stream 51, 53, 62, is arranged to be fed to the inlet of the methanol synthesis unit 220 in admixture with said CO₂ rich feed 201 and/or said H₂ rich feed 202, or in admixture with said first syngas feed 209, or in admixture with said second 205 syngas feed.

In an embodiment, a methanol storage tank is arranged between said methanol synthesis unit 220 and said MTJ section 230, i.e. downstream the methanol synthesis unit and upstream the MTJ section, for storing at least a portion of the effluent stream 221 comprising methanol.

This provides a simple solution for coping with intermittent sources for producing the electricity required in e.g. upstream electrolysis. The methanol storage tank may be arranged downstream said water separation section for removing water. The water separation section is for instance a distillation column. The methanol storage tank accumulates the methanol from e.g. the overhead section of the distillation column, at for instance low pressure, such as less than 5 barg, for instance atmospheric pressure, thus enabling the use of inexpensive materials for such tank while also serving as buffer for any sudden variations in electricity due to the intermittent nature of the source producing it, such as wind and solar energy.

The plant (and process) according to the present invention thus enables not only improving hydrogen (H) and carbon (C) efficiency of the plant, while improving performance and thereby reducing the size of the methanol synthesis unit, for instance a MeOH-loop, but at the same time provides a robust plant which copes with the sudden and often huge variations in electricity supply for e.g. electrolysis of water or steam into the hydrogen required in the syngas feed for methanol production.

In an embodiment, the methanol synthesis unit 220 is arranged for the reformer-based syngas stream 41, 51, 53, 62 being up to up to 50% by volume basis, such as 5-45%, for instance 15-45%, e.g. 10-40% or 20-40% of the inlet of the methanol synthesis unit 220.

Thereby, 5-50%, such as 10-40%; e.g. 15-30% of the effluent stream 221 comprising methanol, is obtained from the recycle streams, i.e. by-product stream rich in paraffins and/or olefins, optionally also off-gas stream(s). The reformer-based syngas stream may thus be 5, 10, 15, 20, 25, 30, 35, 40, 45, 50% volume basis of the inlet of the methanol synthesis unit.

The particular feeding point of the reformer-based syngas to the inlet of the methanol synthesis unit is, for instance, downstream the mixing point of said CO₂ rich feed and/or said H₂ rich feed and upstream the first syngas feed compressor arranged therein, thus in admixture with said first syngas feed, or in admixture with said second syngas feed. The H₂ rich feed from e.g. water electrolysis is provided by a dedicated H₂-compressor. The CO₂ rich feed, suitably after CO₂-gas cleaning, is combined with the H₂ rich feed into said first syngas feed and provided to the methanol reactor of the methanol synthesis unit by the first syngas feed compressor.

In another embodiment, the particular feeding point of the reformer-based syngas to the inlet of the methanol synthesis unit, may be together with the overhead recycle stream of the methanol synthesis unit, as recited below:

In an embodiment, the methanol synthesis unit is a methanol synthesis loop (MeOH loop).

Accordingly, the methanol synthesis unit comprises:
optionally, a cleaning section, such as desulfurisation section, arranged to receive said CO₂ rich feed (201) and/or said H₂ rich feed (202), or said first syngas feed (209); or said second syngas feed (205), thereby providing a cleaned methanol syngas feed, such as a desulfurized methanol syngas feed;
a methanol reactor arranged to receive the cleaned methanol syngas feed, such as the desulfurized methanol syngas feed, and to produce a raw methanol effluent stream;
a first separator arranged to receive the raw methanol effluent stream, and to produce a bottom stream as said effluent stream comprising methanol, suitably after being fed to a second separator such as low-pressure separator from which an off-gas is generated, and an overhead recycle stream;
a recycle compressor arranged to recycle the overhead recycle stream to the methanol reactor.

In an embodiment, the methanol synthesis unit further comprises:
means such as a mixing unit or junction to combine the overhead recycle stream with said CO₂ rich feed and/or said H₂ rich feed, or said first syngas feed, or said second syngas feed; i.e. the overhead recycle is provided in admixture with any of the above streams.

In an embodiment, the methanol synthesis unit may further comprise:
means such as a mixing unit or junction, suitably located downstream said recycle compressor, to combine the reformer-based syngas stream, such as the first, second or third reformer-based syngas stream, with the overhead recycle stream.

It would be understood that the term “junction” may be used interchangeably with the term “juncture”. It denotes a mixing point.

Upstream the methanol reactor, as recited above, suitably as part of the methanol synthesis unit, there may be provided a cleaning section such as a desulfurisation section, for instance a sulfur absorber and sulfur guard, to remove sulfur from a syngas feed, since sulfur is detrimental for the downstream methanol reactor catalyst. By combining the reformer-based syngas with the overhead recycle instead of directly with e.g. the first syngas feed, the volumetric flow to the desulfurisation section remains unchanged, thus avoiding the penalty of increasing the sulfur removal capacity by proving a correspondingly larger desulfurisation section. After being combined with the overhead recycle, the reformer-based syngas is then provided in admixture with said CO₂ rich feed and/or said H₂ rich feed, or in admixture with said first syngas feed, or in admixture with said second syngas feed.

From the overhead recycle stream of the methanol synthesis unit, suitably upstream the recycle compressor, an optional fuel gas stream may be withdrawn from which a hydrogen stream is recovered. This hydrogen stream is herein referred to as excess hydrogen stream from the methanol synthesis unit; and is for instance a hydrogen stream of a hydrogen recovery unit such as a pressure swing adsorption unit (PSA unit), or a hydrogen stream of purge gas scrubber suitably arranged upstream the hydrogen recovery unit, e.g. PSA-unit. Thereby, additional hydrogen is internally produced in the plant or process. The hydrogen stream of the hydrogen recovery unit, e.g. PSA unit, is suitably sent to e.g. the hydrogenation reactor (HYDRO reactor) downstream the oligomerization reactor (OLI reactor) of the MTJ synthesis section of the plant; and/or to the HCR reactor in the upgrading section of the plant. The hydrogen stream of the purge gas scrubber is suitably sent to the hydrogenation section of the reforming system of the plant. The hydrogenation section serves i.a. to remove any olefins being fed to the reforming system.

Accordingly, in an embodiment, the methanol synthesis unit 220 is arranged to provide an excess hydrogen stream, i.e. excess hydrogen stream from the methanol synthesis unit 220; the plant 200 further comprises in said reforming system 100 a hydrogenation section 10, and said hydrogenation section is arranged to receive said excess hydrogen stream from the methanol synthesis unit.

The provision of the excess hydrogen stream from the methanol synthesis unit enables a simpler layout in the reforming system by eliminating the need e.g. a hydrogen recovery section in the reforming system of the plant (such as membrane unit 60 in appended FIG. 1) to provide a hydrogen rich stream and thereby also a hydrogen compressor to send the hydrogen rich stream to the hydrogenation section of the reforming system.

In an embodiment, the MTJ synthesis section 200 comprises: a methanol-to-olefin reactor (MTO reactor) to provide an olefin stream, an oligomerisation reactor (OLI reactor) to provide an oligomerised raw product stream, and a hydroprocessing reactor to provide the raw product 231 containing hydrocarbons boiling in the jet fuel range.

The term “hydroprocessing” means hydrotreatment and comprises any of: hydrogenation (HYDRO) in a HYDRO reactor, hydrocracking (HCR) in a HCR reactor, hydroisomerization (HDI) in a HDI reactor, or combinations thereof. These are well known technologies in the art. For instance, applicant's WO 2021180805 discloses the associated catalysts and operating conditions. Applicant's WO 2022063992 discloses associated catalysts and operating conditions for i.a. hydrogenation.

For the purposes of the present application, the optional upgrading section comprises a a hydrocracking (HCR) reactor and/or a fractionation unit. Hence, in an embodiment, the optional upgrading section comprises a fractionation unit. The optional upgrading section may further comprise a HYDRO reactor, for instance a HYDRO reactor upstream or downstream the fractionation unit. Preferably, the optional upgrading section comprises a HCR reactor and a fractionation unit.

It would thus be understood that, for instance, a HYDRO reactor may be provided in the MTJ section of the plant, and/or in the upgrading section of the plant. For instance also, a HYDRO reactor may be provided in the MTJ synthesis section of the plant, and a HCR reactor may be provided in the upgrading section of the plant.

In an embodiment, the hydroprocessing reactor of the MTJ section is a hydrogenation (HYDRO) reactor.

In an embodiment, the MTJ synthesis section 230 comprises a methanol-to-olefin reactor (MTO reactor), an olefin reactor (OLI reactor) and a hydrogenation reactor (HYDRO reactor), and the MJT synthesis section may further comprise a separator in between the OLI reactor and HYDRO reactor, and/or downstream the HYDRO reactor, in order to provide the by-product stream rich in paraffins and/or olefins. Hence, more specifically, in an embodiment, the MTJ synthesis section 230 comprises a methanol-to-olefin reactor (MTO reactor) to provide an olefin stream, an oligomerisation reactor (OLI reactor) to provide an oligomerised raw product stream, and a hydrogenation reactor (HYDRO reactor) to provide the raw product 231 containing hydrocarbons boiling in the jet fuel range; and wherein the MTJ synthesis section 230 further comprises:
a separator between the OLI reactor and HYDRO reactor, which is arranged to receive at least a portion of the oligomerised raw product stream and separate therefrom at least a portion of said by-product stream 242 rich in paraffins and/or olefins;
   and/or
a separator downstream the HYDRO reactor which is arranged to receive at least a portion of the raw product 231 containing hydrocarbons boiling in the jet fuel range, and separate therefrom at least a portion of said by-product stream 242 rich in paraffins and/or olefins.

It would thus be understood that the MTJ synthesis section may also comprise a separator, such as a fractionation unit.

In the MTJ section of the plant, the oxygenate such as methanol is converted to olefins in a methanol to olefins reactor (MTO reactor). As is well-known in the art, in the MTJ section, the methanol may be first converted to dimethyl ether (DME) and then an oxygenate stream comprising methanol and/or DME is converted to olefins in the MTO reactor. The olefin stream from the MTO reactor and comprising C4-C8 olefins, optionally also higher olefins already in the jet fuel range, is oligomerized and hydrogenated in the OLI reactor and HYDRO reactor to the relevant cut for jet fuel, namely C8-C19, such as C8-C16 paraffins.

In an embodiment, the MTO reactor of the MTJ section of the plant is provided with a conversion catalyst comprising a zeolite with a framework having a 10-ring pore structure, said 10-ring pore structure being a unidimensional (1D) pore structure; said 1D pore structure is any of “MRE (ZSM-48), MTT (ZSM-23), TON (ZSM-22), or combinations thereof.

A 1D zeolite, such as ZSM-48, enables the production of a high proportion of olefins already in the jet fuel range, hence reducing the load to the downstream OLI reactor. Suitably, the conversion catalyst is provided in a fixed bed.

The by-product stream being separated between the OLI reactor and the HYDRO reactor is rich in olefins. Accordingly, in an embodiment the by-product stream rich in paraffins and/or olefins, is a stream comprising at least 50 wt %, such as at least 60 wt %, or at least 75 wt %, or at least 90 wt % olefins. For instance, this stream comprises 60-80 wt % olefins, and 20-40 wt % paraffins.

Downstream the hydroprocessing reactors, such as HYDRO reactor, there may be provided a separator arranged to receive the raw product containing hydrocarbons boiling in the jet fuel range and separate therefrom said by-product stream rich in paraffins and/or olefins. This stream contains therefore mainly paraffins below said range C8-C19, such as C3-C7 paraffins.

Accordingly, in an embodiment, the by-product stream rich in paraffins and/or olefins, is a stream comprising at least 50 wt %, such as at least 60 wt %, or at least 75 wt %, or at least 90 wt % paraffins including n- and i-paraffins, optionally also olefins. For instance, this stream may contain about 90 wt % paraffins including n- and i-paraffins, and about 10 wt % naphthenes. In a particular embodiment, the by-product stream rich in paraffins and/or olefins is a stream rich in C3-C7 paraffins, including n- and i-paraffins, optionally also olefins. In another particular embodiment, the by-product stream rich in paraffins and/or olefins is a naphtha stream. As used herein, “naphtha stream” means C5-C9 hydrocarbons boiling in the range 30-160° C., such as C5-C8 hydrocarbons, e.g. C5-C8 olefins.

The by-product stream rich in paraffins and/or olefins may also be provided by the upgrading section of the plant, e.g. by a hydrocracking reactor (HCR reactor) and/or fractionation unit arranged therein. For instance, the by-product stream rich in paraffins and/or olefins may be a stream rich in propane and/or butane, such as a liquified petroleum gas (LPG) stream. For instance also, the by-product stream rich in paraffins and/or olefins may be a naphtha stream, as mentioned above.

The term “rich in C3-C7” paraffins means at least 50%, such as at least 60%, preferably at least 75% of this by-product stream is C3-C7 paraffins. C8 or higher (C8+) paraffins, in particular C8-C19 such as C8-C16 paraffins, are withdrawn instead as the main hydrocarbon components of jet fuel. The term “rich in propane and/or butane” means that at least 50%, such as at least 60%, preferably at least 75% of this by-product stream is propane and/or butane. Typically, LPG contains 70-80 vol % butane, 20-30 vol % propane and some other hydrocarbons. Hence, in an embodiment, the by-product stream rich in paraffins and/or olefins is an LPG stream (LPG feed). LPG is typically a mix of lighter hydrocarbons, such as propane and butane. Propylene, butylenes and various other hydrocarbons are usually also present in LPG in small concentrations such as C₂H₆, CH₄ etc. An LPG stream may also comprise olefins.

In an embodiment, the jet fuel synthesis plant is further arranged to provide one or more off-gas streams, said one or more off-gas streams 253, 253′ being one or more waste-gas streams rich CO₂, H₂, CH₄, and said reforming system is arranged to receive at least a portion of said one or more off-gas stream(s) 253, 253′.

For the purposes of the present application, an off-gas stream is regarded separately from a by-product stream rich in paraffins and/or olefins. The latter is regarded as a by-product stream, the former as a waste gas stream.

Hence, for the purposes of the present application, the off-gas stream(s) is a waste-gas streams comprising CO₂, H₂, CH₄, and optionally higher hydrocarbons etc. which are also produced in the jet fuel synthesis plant. For instance, an off-gas stream may come from the methanol synthesis unit (e.g. methanol loop); e.g. the off-gas stream is from a separation unit, such as low pressure separation unit, arranged in the methanol synthesis unit. Other off-gas streams may come from the upgrading section of the jet fuel synthesis plant. Other off-gas streams may come from the MTJ section of the jet fuel synthesis plant, for instance from the MTO reactor (methanol to olefin reactor) therein. As already mentioned, the off-gas streams often have no efficient use, apart from using them in fired equipment, such as in fired heaters, which causes CO₂ emission. These off-gas streams are now recycled as part of the jet fuel synthesis process itself, in order to i.a. improve overall C-efficiency of the plant and process, and/or also H-efficiency.

The use of particularly an e-SMR, alone or together with an upstream pre-reformer, as already recited, allows recycling of the by-product stream rich in paraffins and/or olefins, such as LPG and/or naphtha stream, optionally also an off-gas stream, such that additional CO₂ emissions can be avoided, or significantly minimized.

The one or more additional off-streams in the plant are arranged to be fed to the reforming system, optionally in combination with said by-product stream rich in paraffins and/or olefins.

In an embodiment, the reforming system of the plant further comprises a separation section arranged to receive at least a portion of said first reformer-based syngas stream and separate it into at least said second reformer-based syngas stream and a process condensate. This separation section advantageously removes water from the first syngas stream, which is detrimental for its use in methanol synthesis.

The reforming system may comprise said hydrogenation section, which is arranged to receive the first reforming feed stream, i.e. the by-product stream rich in paraffins and/or olefins, optionally also an off-gas stream, and provide a hydrogenated first reforming feed stream. In the hydrogenation section, the first reforming feed stream is mixed with a hydrogen feed, suitably an excess hydrogen stream from the methanol synthesis unit of the plant, as earlier recited, and passed over a catalyst active in hydrogenation. Again, the provision of excess hydrogen stream from the methanol synthesis unit enables a simpler layout without the need of a hydrogen recovery section in the reformer-based syngas to provide a hydrogen rich stream and thereby a hydrogen compressor to send the hydrogen rich stream to the hydrogenation section, as e.g. illustrated in appended FIG. 1. The hydrogenation section may comprise one or more hydrogenation reactors in series. Hydrogenation converts unsaturated hydrocarbon components, such as olefins, e.g. as propylene or butylene, to the corresponding saturated hydrocarbons, which can reduce or avoid carbon formation (in a reforming step) by converting olefins into alkanes. Hydrogenation catalysts and reactors suitable for such processes are commercially available and known to the skilled person.

The reforming system may also comprise a desulfurisation section arranged to receive the hydrogenated first reforming feed stream, and provide a desulfurised first and/or second reforming feed stream. Typically, the desulfurisation section comprises one or more hydrodesulfurization (HDS) reactors. Desulfurisation converts sulfur-containing compounds in the first stream to hydrocarbons (typically saturated hydrocarbons) and sulfur-containing compounds (e.g., H₂S) as by-product. This can reduce catalyst poisoning in subsequent conversion steps. Desulfurisation catalysts and reactors suitable for such processes are commercially available and known to the skilled person. Substances other than sulfur that might need to be removed in such a purification step include chlorine, dust and heavy metals.

A pre-reforming section, i.e. a pre-reformer (or interchangeably, a pre-reforming unit), may be arranged to receive the first reforming feed stream and carry out a pre-reforming step. A pre-reformed stream is provided. Pre-reforming is an additional reforming step, which allows a syngas with a desired composition to ultimately be obtained, i.e. in which higher hydrocarbons are converted to methane. Pre-reforming suitably takes place at ca. 350-700° C. to convert higher hydrocarbons as an initial step. Pre-reforming catalysts and reactors suitable for such processes are commercially available and known to the skilled person. Pre-reformer units used in the present invention are catalyst-containing reactor vessels and are typically adiabatic. In the pre-reforming units, heavier hydrocarbon components in the hydrocarbon feedstock are steam reformed and the products of the heavier hydrocarbon reforming are methanated. The skilled person can construct and operate suitable pre-reformer units as required. Pre-reformer units suitable for use in the present system/process are provided in applicant's co-pending applications EP20201822 and EP21153815. The pre-reformed stream comprises methane, hydrogen, carbon monoxide and also carbon dioxide. The pre-reformed stream at the outlet of the prereformer may be in the temperature range: 400° C.-500° C.

As the first reformer-based syngas stream is at an elevated temperature (e.g. 900-1100° C.) at the outlet of the reformer, it can advantageously be heat-exchanged with upstream components in the system, for effective energy use in the reforming system. The reforming system may therefore comprise one or more heat exchangers, being arranged to provide heat exchange between the first syngas stream and one or more of: the first reforming feed stream, the desulfurised first reforming feed stream and boiler feed water stream. Suitably, the first reformer-based syngas stream is heat exchanged with the desulfurised first reforming feed stream first, then a boiler feed water stream, and then with the first reforming feed stream. Alternatively, or additionally, one or more electrical heaters may be used to raise the temperature of one or more of: the first reforming feed stream, the hydrogenated first reforming feed stream, the desulfurised first reforming feed stream and boiler feed water stream.

As explained above, the reforming system may further comprise a second reforming feed stream being an off-gas stream comprising CO₂, H₂ and CH₄, said second stream suitably being arranged to be mixed with the first reforming feed stream, upstream the inlet of the reformer, for instance upstream the inlet of an e-SMR or an ATR

In an embodiment, the reforming system comprises a hydrogen recovery section, said hydrogen recovery section being arranged to receive at least a portion of the second reformer-based based syngas stream and provide at least a hydrogen-rich stream and a fourth reformer-based syngas stream; and at least a portion of the second reformer-based syngas stream and at least a portion of the fourth reformer-based syngas stream are arranged to be combined to a combined syngas stream as said third reformer-based syngas stream. The hydrogen recovery section may comprise a membrane hydrogen separation unit or a PSA (pressure swing adsorption) unit or both.

At least a portion of the hydrogen-rich stream obtained from the hydrogen recovery section and/or a portion of the second syngas stream from the separation section may be used in the hydrogenation section of the reforming system. Therefore, at least a portion of the hydrogen-rich stream may be combined with e.g. the first reforming feed stream upstream the hydrogenation section. Alternatively, or additionally, recovered H₂ can also be used in the hydroprocessing reactor, such as hydrogenation reactor (HYDRO reactor), of the MTJ synthesis section.

Further integration and improved hydrogen-efficiency-by internal sourcing of hydrogen-of the jet fuel synthesis plant is thereby also achieved.

As recited earlier, the methanol synthesis unit is suitably arranged to provide an excess hydrogen stream.

Accordingly, in an embodiment, the methanol synthesis unit 220 is arranged to provide an excess hydrogen stream, i.e. excess hydrogen stream from the methanol synthesis unit 220;—wherein the MTJ synthesis section comprises a methanol-to-olefin reactor (MTO reactor), and olefin reactor (OLI reactor) and a hydrogenation reactor (HYDRO reactor); and said HYDRO reactor is arranged to receive: a portion of the first or second H₂ rich feed comprising H₂; and/or said excess hydrogen stream from the methanol synthesis unit 220; such as a portion of said excess hydrogen stream from the methanol synthesis unit 220; optionally, a portion of the hydrogen-rich stream from hydrogen recovery section 60 of the reforming system 100;

and/or
wherein said optional upgrading section 240 comprises a HCR reactor and the HCR reactor is arranged to receive: a portion of the first or second H₂ rich feed 202, 202′ comprising H₂, and/or said excess hydrogen stream from the methanol synthesis unit 220, such as a portion of said excess hydrogen stream from the methanol synthesis unit 220.
wherein said reforming system 100 is arranged to receive said excess hydrogen stream from the methanol synthesis unit 220, such as a portion of said excess hydrogen stream from the methanol synthesis unit 220; said reforming system 100 comprises a hydrogenation section 10, and said hydrogenation section 10 is arranged to receive said excess hydrogen stream 255 from the methanol synthesis unit 220.

More generally, the methanol synthesis unit is arranged to provide an excess hydrogen stream, i.e. excess hydrogen stream from the methanol synthesis unit; the MTJ synthesis section comprises a methanol-to-olefin reactor (MTO reactor), and olefin reactor (OLI reactor) and a hydroprocessing reactor, such as a hydrogenation reactor (HYDRO reactor); and said hydroprocessing reactor, e.g. HYDRO reactor, is arranged to receive: a portion of the first or second H₂ rich feed comprising H₂; and/or said excess hydrogen stream from the methanol synthesis unit; such as a portion of said excess hydrogen stream from the methanol synthesis unit; optionally, a portion of the hydrogen-rich stream from hydrogen recovery section of the reforming system. See appended FIG. 6 and FIG. 1.

Thereby, hydrogen required for the e.g. the HYDRO reactor is also sourced internally, rather than costly external sourcing from outside the battery limits of the plant. The excess hydrogen stream from the methanol synthesis unit is suitably generated from the overhead recycle stream, for instance by providing said hydrogen recovery unit, such as a pressure swing adsorption (PSA) unit arranged to receive a portion of the overhead recycle stream.

The MTJ synthesis section is for instance as disclosed in applicant's WO 2022063992. The jet fuel product stream is thereby in accordance with the requirements to qualify as a sustainable aviation fuel (SAF), in compliance with ASTM D7566 and ASTM D4054.

The invention provides also a process for jet fuel synthesis of a first CO₂ rich feed 201 comprising CO₂, and a first H₂ rich feed 202 comprising H₂, or of a first syngas feed 209 which combines said first CO₂ rich feed 201 and said first H₂ rich feed 202; or of a second syngas feed 205 comprising a carbon oxide and hydrogen, said process comprising the steps of:
providing a jet fuel synthesis plant 200, according to any one of the above embodiments;
supplying CO₂ rich feed 201 and H₂ rich feed 202, or said first syngas feed; or said second syngas feed 205, to the methanol synthesis unit 220, and providing an effluent stream 221 comprising methanol;
supplying at least a portion of the effluent stream 221 comprising methanol from the methanol synthesis unit 220 to the methanol-to-jet fuel (MTJ) synthesis section 230, and providing a raw product 231 containing hydrocarbons boiling in the jet fuel range;
supplying at least a portion of the raw product 231 from the MTJ synthesis section 230 to optional upgrading section 240, and providing a jet fuel product stream 241; said optional upgrading section 240 comprising: a hydrocracking (HCR) reactor and/or a fractionation unit, thereby providing said jet fuel product stream 241;
withdrawing from the MTJ section 230 and/or the upgrading section 240 a by-product stream 242, 242′ rich in paraffins and/or olefins; optionally one or more off-gas streams 253, 253′, such as a second stream 253 from the methanol synthesis unit 220 and/or second stream 253′ from the optional upgrading section 240;
supplying at least a portion of a first reforming feed stream 1 as said by-product stream 242, 242′ rich in paraffins and/or olefins, optionally at least a portion of said one or more off-gas streams, to reforming system 100, performing a reforming step in reforming unit (reformer, 40), and providing an reformer-based syngas stream 41, 51, 53, 62, such as a first, second or third reformer-based syngas stream 41, 51, 53;
supplying at least a portion of said reformer-based syngas stream 41, 51, 53, 62 to the inlet of the methanol synthesis unit 220, preferably in admixture with said CO₂ rich feed 201 and/or said H₂ rich feed 202, or in admixture with said first syngas feed 209; or in admixture with said second syngas feed 205;
wherein the process does not comprise steam reforming of a hydrocarbon feed gas for proving said first 209 or said second syngas feed 205;

As in connection with plant (MTJ plant), in an embodiment, the reforming system the reforming step is any of: steam reforming in a steam methane reformer (SMR) i.e. tubular reformer, electrical steam reforming (electrically heated reforming) in an electrical steam methane reformer (e-SMR), autothermal reforming in an autothermal reformer (ATR), convection heated reforming in a convection heated reformer such as a heat exchange reformer (HER), and combinations thereof.

In an embodiment, the reforming step of the reforming system is:
electrical steam reforming in an electrical steam methane reformer (e-SMR), which is arranged alone or together with an upstream pre-reformer;
   or
autothermal reforming in an autothermal reformer (ATR), which is arranged alone or together with an upstream pre-reformer.

Thus, in a particular embodiment, as in connection with the plant (MTJ synthesis plant), the process does not comprise a primary reforming step in connection with said e-SMR reforming step or autothermal reforming step, such as a steam methane reforming (SMR) prior to the e-SMR step or autothermal reforming step; or convection heated reforming such as in a heat exchange reformer operating in parallel or in series with the e-SMR. Hence, again, other than pre-reforming, there is only e-SMR or autothermal reforming in the reforming system.

In an embodiment, the methanol synthesis unit 220 provides an excess hydrogen stream 255, and the process further comprises supplying at least a portion of said excess hydrogen stream 255 to said reforming system 100. In a particular embodiment, said reforming system 100 comprises a hydrogenation section 10, and the process further comprises supplying at least a portion of said excess hydrogen stream 255 to said hydrogenation section 10.

In an embodiment, said first reforming feed 1, 242, 242′ is less than 15 wt % of said raw product 231 containing hydrocarbons boiling in the jet fuel range, or less than 15 wt % of said jet fuel product stream 241.

In an embodiment, the process further comprises:
an electrolysis step of water feedstock 203 to provide a second H₂ rich feed 202′ comprising H₂, optionally as said first H₂ rich feed 202 comprising H₂;
and/or, an electrolysis step of a second CO₂ rich feed 201′ comprising CO₂ to provide a CO-enriched feed 204; and combining the first or second H₂ rich feed 202′ comprising H₂ and the CO-enriched feed (204) to provide said second syngas feed 205;
   or
a thermal decomposition step, such as gasification, of a biomass feedstock for providing a crude syngas feed, and a purification step of the crude syngas feed for providing said second syngas feed 205;
   or
a reverse water gas shift (rWGS) step, preferably in an electrical rWGS (e-rWGS) unit, of a portion of said first CO₂ rich feed (201) comprising CO₂ and a portion of said first H₂ rich feed 202 comprising H₂, to provide a rWGS syngas feed; and then combining the rWGS syngas feed with the remaining portion of: said first CO₂ rich feed 201 comprising CO₂, and said first H₂ rich feed 202 comprising H₂, to provide said second syngas feed 205; and optionally, supplying a portion of said by-product stream 242, 242′ rich in paraffins and/or olefins to the rWGS unit.

Hence, the process does not comprise steam reforming for preparing the first or second syngas feed. Yet, the process may be provided with a reverse water gas shift step in a reverse water gas shift unit (rWGS unit) for preparing said first or second syngas feed.

In an embodiment, up to 50% by volume basis, such as 5-45%, for instance 15-45%, e.g. 10-40% or 20-40% of the inlet of the methanol synthesis unit (220) is from the reformer-based syngas 41, 51, 53, 62. Thereby, as in connection with the jet fuel synthesis plant embodiments, 5-50%, such as 5-45%, e.g. 10-40%; or 20-40%, or e.g. 15-30% of the effluent stream 221 comprising methanol, is obtained from the recycle streams, i.e. by-product stream rich in paraffins and/or olefins, optionally also off-gas stream(s).

In an embodiment, the process further comprising supplying at least a portion of the effluent stream 221 comprising methanol to a methanol storage tank, said methanol storage tank being provided between said methanol synthesis unit 220 and said MTJ synthesis section 230.

In an embodiment, the MTJ synthesis section comprises a MTO reactor provided with a conversion catalyst comprising a zeolite with a framework having a 10-ring pore structure, said 10-ring pore structure being a unidimensional (1D) pore structure. In a particular embodiment, said 1D pore structure is any of “MRE (ZSM-48), MTT (ZSM-23), TON (ZSM-22), or combinations thereof.

In an embodiment, the reformer-based syngas stream 41, 51, 53, 62, is a first, second or third reformer-based syngas stream 41, 51, 53.

In an embodiment, the process further comprises:
supplying in reforming system 100 at least a portion of the reformer-based syngas stream as a first syngas stream 41 to separation section 50, and separating it therein into at least second syngas stream 51 and process condensate 52.

In an embodiment, the step of supplying at least a portion of said by-product stream 1, 242, 232′ rich in paraffins and/or olefins, optionally at least a portion of said one or more off-gas streams, to said reforming system 100, and providing the reformer-based syngas stream 41, 51, 53, 62, such as a first, second or third syngas stream 41, 51, 53, comprises:
optionally, hydrogenating the first reforming feed stream 1 in the hydrogenation section 10 to provide a hydrogenated first reforming feed stream 11;
optionally, desulfurising said hydrogenated first reforming feed stream 11 in desulfurisation section 20, to provide a desulfurised first reforming feed stream 21;
pre-reforming the first reforming feed stream 21 in pre-reforming section 30, to provide a pre-reformed first reforming feed stream 31;
performing said reforming step on said first reforming feed stream 1, 11, 21, 31 to provide said first syngas stream 41.

In an embodiment, the MTJ synthesis section 230 comprises a methanol-to-olefin step (MTO step) in the MTO reactor, a subsequent oligomerisation step (OLI step) in the OLI reactor and a hydroprocessing step in a hydroprocessing reactor, such as a hydrogenation (HYDRO) step in a HYDRO reactor.

In an embodiment, the MTJ synthesis section 230 comprises a methanol-to-olefin step (MTO step) in the MTO reactor, a subsequent oligomerisation step (OLI step) in the OLI reactor and a hydrogenation step (HYDRO step) in the HYDRO reactor, and the process further comprises:
supplying a portion of the first H₂ rich feed 202 comprising H₂ to said HYDRO step; and/or supplying an excess hydrogen stream from the methanol synthesis unit 220 to said HYDRO step; optionally, supplying a portion of a hydrogen-rich stream 61 from hydrogen recovery section 60 of reforming system 100 to said HYDRO step.

More specifically, in an embodiment:
the MTJ synthesis section 230 comprises a methanol-to-olefin step (MTO step) in the MTO reactor, a subsequent oligomerisation step (OLI step) in the OLI reactor and a hydrogenation step (HYDRO step) in the HYDRO reactor, and the process further comprises: supplying a portion of the first H₂ rich feed 202 comprising H₂ to said HYDRO step; and/or supplying an excess hydrogen stream 255 from the methanol synthesis unit 220, such as a portion of said excess hydrogen stream 255 from the methanol synthesis unit 220, to said HYDRO step; and/or
the upgrading section 240 comprises a hydrocracking (HCR) step in the HCR reactor, and the process further comprises: supplying a portion of the first H₂ rich feed 202 comprising H₂ to said HYDRO step, and/or supplying an excess hydrogen stream 255 from the methanol synthesis unit 220, such as a portion of said excess hydrogen stream 255 from the methanol synthesis unit 220, to said HYDRO step.

In an embodiment, the by-product stream 242, 242′ rich in paraffins and/or olefins, is a stream comprising at least 50%, such as at least 60%, or at least 75%, or at least 90% paraffins including n- and i-paraffins, optionally also olefins; or wherein the by-product stream 242, 242′ rich in paraffins and/or olefins, is a stream comprising at least 50 wt %, such as at least 60 wt %, or at least 75 wt %, or at least 90 wt % olefins.

In an embodiment, said one or more off-gas streams 253, 253′ are one or more waste-gas streams rich CO₂, H₂, CH₄, and the process further comprises supplying at least a portion of said one or more off-gas stream(s) 253, 253′ to said reforming system 100.

In an embodiment, the methanol synthesis unit 220 provides an excess hydrogen stream 255, wherein MTJ synthesis section 230 comprises a methanol-to-olefin reactor (MTO reactor), an olefin reactor (OLI reactor) and a hydrogenation reactor (HYDRO reactor); and wherein a portion of the first or second H₂ rich feed 202, 202′ comprising H₂; and/or said excess hydrogen stream from the methanol synthesis unit 220, such as a portion of said excess hydrogen stream 255 from the methanol synthesis unit 220, is supplied to said HYDRO reactor.

More generally, in an embodiment, the methanol synthesis unit 220 provides an excess hydrogen stream 255, wherein MTJ synthesis section 230 comprises a methanol-to-olefin reactor (MTO reactor), an olefin reactor (OLI reactor) and a hydroprocessing reactor (HYDRO reactor); and wherein a portion of the first or second H₂ rich feed 202, 202′ comprising H₂; and/or said excess hydrogen stream from the methanol synthesis unit 220, such as a portion of said excess hydrogen stream 255 from the methanol synthesis unit 220, is supplied to said HYDRO reactor.

In an embodiment, the methanol synthesis unit 220 provides an excess hydrogen stream 255, said optional upgrading section 240 comprises a HCR reactor, wherein a portion of the first or second H₂ rich feed 202, 202′ comprising H₂, and/or said excess hydrogen stream from the methanol synthesis unit 220, such as a portion of said excess hydrogen stream from the methanol synthesis unit 220, is supplied to the HCR reactor.

In an embodiment, the methanol synthesis unit 220 provides an excess hydrogen stream (255), wherein said excess hydrogen stream from the methanol synthesis unit 220, such as a portion of said excess hydrogen stream from the methanol synthesis unit 220, is supplied to the reforming system 100; preferably, said reforming system 100 comprising a hydrogenation section 10, and wherein said excess hydrogen stream 255 is supplied to said hydrogenation section 10.

It would be understood that any of the embodiments and associated benefits in connection with the jet fuel synthesis plant, are applicable to the process, and thus may be used in connection with the corresponding embodiments of the process; or viceversa.

### Specific Embodiments

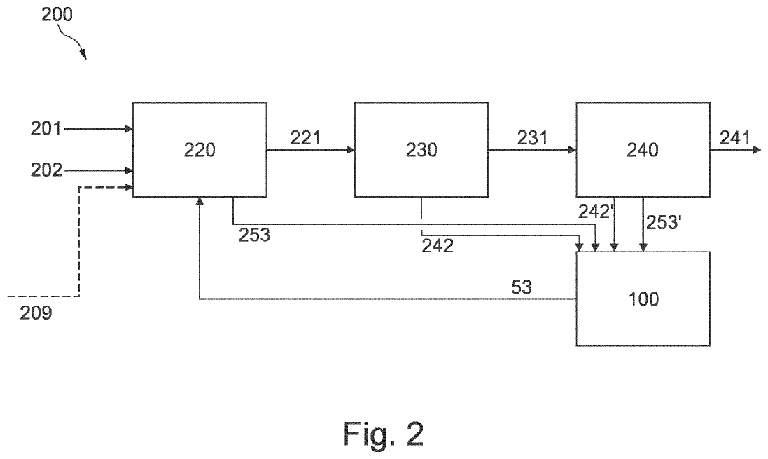

FIG. 1 shows a layout of the reforming system 100. A first reforming feed stream 1, corresponding to by-product stream 242, 242′ rich in paraffins and/or olefins in FIG. 2, is compressed in first pump 69. It would also be understood that the first reforming feed stream 1 may also be provided as one or more off-gas streams 253, 253′. The compressed first reforming feed stream′ is—in this layout—mixed with hydrogen rich stream 61 at mixer 68 before being passed through heat exchangers 64, 63 to heat exchange with the first syngas stream 41. The heated first reforming feed stream 1 is hydrogenated in hydrogenation section 10 to provide a hydrogenated first reforming feed stream 11 which is subsequently desulfurised in desulfurisation section 20, to provide a desulfurised first reforming feed stream 21. This desulfurised first reforming feed stream 21 may be mixed with process steam 22, and the mixed stream is again heat exchanged with the first syngas stream 41. The desulfurised first reforming feed stream 21 is pre-reformed in pre-reforming section 30, to provide a pre-reformed stream 31. Electrical steam methane reforming (e-SMR) is performed on the pre-reformed stream 31 in electrical steam methane reformer (e-SMR, 40), for which electrical power is illustrated by the “lightning” symbol, to provide an e-SMR based syngas stream, such as a first syngas stream 41. First syngas stream 41 is then heat exchanged with boiler feed water 90 in waste heat boiler 62, providing export steam 91. Subsequently, first syngas stream 41 is passed through heat exchangers 64, 63 (as noted above), and then heat-exchanged once more with boiler feed water 90 in heat exchanger 65. Additional cooling takes place in cooling unit 66. The first e-SMR based syngas stream 41 is passed to a separation section 50 where it is separated into at least a second e-SMR based syngas stream 51 and a process condensate 52.

A portion of the second syngas stream 51 is optionally passed to hydrogen recovery section 60, where a hydrogen-rich stream 61 is separated and a fourth e-SMR based syngas stream 62 is provided. A portion of the second e-SMR based syngas stream 51 and a portion of the third e-SMR based syngas stream 62 are combined to a combined e-SMR based syngas stream, namely third e-SMR based syngas stream 53. The hydrogen-rich stream 61 is compressed at compressor 67, and then combined with the first reforming feed stream 1 upstream the hydrogenation section 10 (as noted above).

Overall, in the illustrated system of FIG. 1, first feed rich in paraffins, optionally also an off-gas stream, to the reforming plant are hydrogenated, desulfurized and pre-reformed before sending it to e-SMR. The effluent stream from the e-SMR (first e-SMR based syngas stream) gets cooled in series of heat exchangers by pre-reformer feed preheat, steam generation in waste heat boiler, feed preheater, first feed vaporizer, preheating of boiler feed water etc. The water in the effluent stream gets condensed and then separated, thereby providing a second e-SMR based syngas stream. A part of e-SMR based syngas is then used for H2 recovery for internal use for hydrogenation and pre-reforming, or for the HYDRO reactor in the MTJ synthesis section. The rest of the e-SMR based syngas is sent as a third e-SMR based syngas stream to the methanol synthesis unit, as illustrated in FIG. 2.

FIG. 2 shows a jet fuel synthesis plant 200 according to the invention. A system 100, as per FIG. 1 is provided to make recycling of the first reforming feed stream 1 possible. It would be understood, that in the plant 200 of FIG. 2, stream 242, 242′ corresponds to the first reforming feed stream 1 in FIG. 1. It would also be understood that the first reforming feed stream 1 may also be provided as one or more off-gas streams 253, 253′. A first CO₂ rich feed 201 comprising CO₂ and a first H₂ rich feed 202 comprising H₂, suitably after combining them into a first syngas feed 209, are sent to methanol synthesis unit 220 (methanol loop 220), from which an effluent stream 221 comprising methanol is provided. From the methanol loop 220 an off-gas stream 253, suitably from a low-pressure separation unit arranged therein (not shown) is generated and fed to the reforming system 100, as so is another off-gas stream 253′ from the upgrading section 240. The effluent stream comprising methanol 221 is supplied to MTJ synthesis section 230 comprising a methanol-to-olefin reactor (MTO reactor), and olefin reactor (OLI reactor) and a hydrogenation reactor (HYDRO reactor) (not shown), and a raw product 231 containing hydrocarbons boiling in the jet fuel range, namely C8-C19, e.g. C8-C16, is provided. From the MTJ section 230, suitably between the OLI and HYDRO reactor, and/or downstream a HYDRO reactor, a by-product stream rich in paraffins and/or olefins 242 is fed to the reforming system 100. The upgrading section 240 may also provide a by-product stream 242′ rich in paraffins and/or olefins. The raw product 231, i.e. raw jet fuel product, is fed to an upgrading section 240, where it is upgraded to a jet fuel product stream 241 under optional generation of an off-gas stream 253′. The by-product stream rich in paraffins and/or olefins 242, 242′ is fed to a system 100 as described above, and a reformer-based stream such as third e-SMR based syngas stream 53 is provided, which is then recycled to the methanol synthesis unit 220. From the reforming system 100, the first or second reformer-based stream, such as first or second e-SMR based syngas stream 41, 51, may also be recycled to the methanol synthesis unit 220 (not shown).

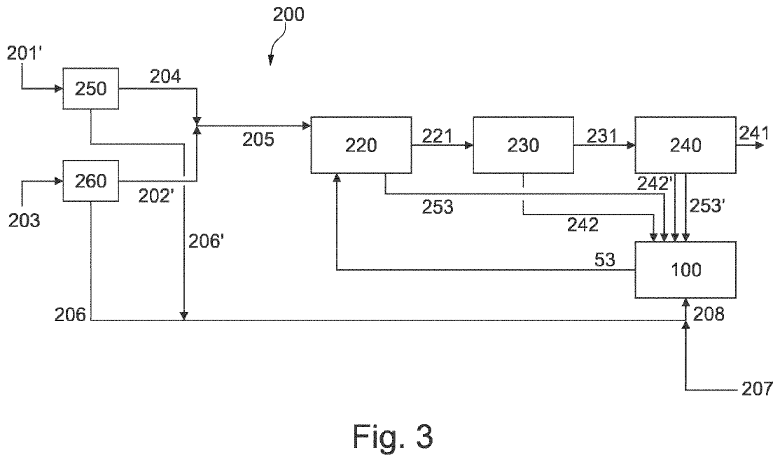

The reformer-based, syngas, such as here e-SMR based syngas 41, 51, 53, is a minor syngas stream to the gasoline synthesis plant 200, more specifically to the methanol synthesis unit 220, compared to the major syngas stream thereto, namely the first syngas feed (resulting from combining the first CO₂ rich feed 201 and the first H₂ rich feed 202; or compared the second syngas feed resulting from combining electrolysis of CO₂ and water/steam, as illustrated in FIG. 3, or for instance also by the thermal decomposition of a biomass feedstock, i.e. a solid renewable feed. The reformer-based based syngas 41, 51, 52, 53, 62 is less than 50%, such as 15-45% (volume basis), for instance in the range 20-40%, of the first syngas feed. Compared to the prior art, where a reforming system is provided in the main syngas stream to the gasoline synthesis plant, thus corresponding to the first or second syngas feed to methanol synthesis unit, the present invention enables a much smaller reforming system 100, with significantly reduced plot size and attendant capital and operating expenses.

FIG. 3 shows a gasoline synthesis plant 200 as in FIG. 2, in which the methanol synthesis unit 220 is now fed with second syngas feed 205. The plant 200 comprises an electrolysis unit 260 arranged to receive a water feedstock 203, i.e. steam and/or water, and provide a second H₂ rich feed 202′ comprising H₂; optionally as said first H₂ rich feed 202, as well as first oxygen stream 206. The plant 200 further comprises an electrolysis unit 250 arranged to receive a second CO₂ rich feed 201′, or the first CO₂ rich feed 201 of FIG. 2 comprising CO₂, or a portion thereof, and provide a CO-enriched feed stream 204, as well as second oxygen stream 206′. Suitably also, a portion of the second CO₂ rich feed 201′ may bypass the electrolysis unit 250 and combine with the CO-enriched feed stream 204 (not shown). A mixing unit or junction (not shown) serves to combine streams 202′ and 204 into second syngas feed 205, having a molar ratio of CO/CO₂ higher than 1, for instance 10 or higher, thus also enabling a more reactive syngas for methanol synthesis in methanol synthesis unit 220. A mixing unit or junction (not shown) combine a steam stream 207 with first oxygen stream 206 and/or second oxygen stream 206′, to provide an oxidant stream 208, which may be fed to reforming system 100, suitably where the reformer 40 is an autothermal reformer (ATR). The third reformer-based syngas 53 is suitably admixed to the second syngas feed 205 to provide a more reactive methanol feed gas as the inlet to methanol synthesis unit 220.

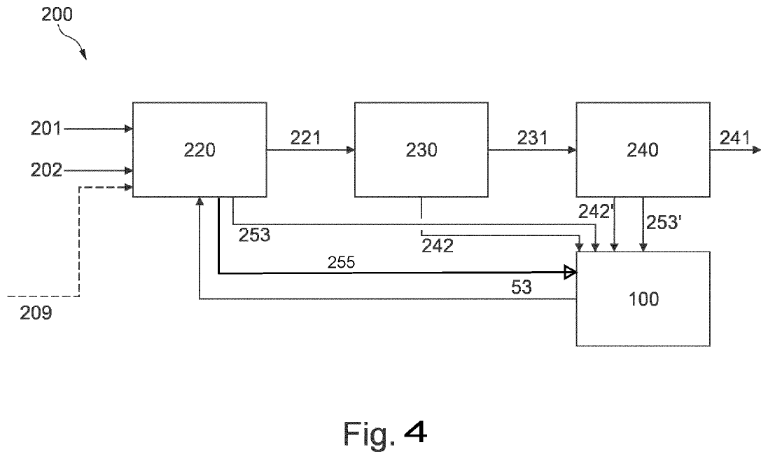

FIG. 4 shows the jet fuel synthesis plant 200 as in FIG. 2, and further comprising excess hydrogen stream 255. Hence, the methanol synthesis unit 220 is arranged to provide the excess hydrogen stream 255, while the reforming system 100 suitably comprises a hydrogenation section 10, as shown in FIG. 1, and which is further arranged to receive said excess hydrogen stream 255; hence, said excess hydrogen stream 255 or a portion thereof is supplied to said hydrogenation section 50. Excess hydrogen stream 255 may also be provided (not shown) to a hydroprocessing reactor in the plant, such as a to HYDRO reactor in MTJ synthesis section 230 and/or HCR reactor in upgrading section 240 and/or a HYDRO reactor in upgrading section 240.

The present invention has been described with reference to a number of embodiments and figures. However, the skilled person is able to select and combine various embodiments within the scope of the invention, which is defined by the appended claims. All documents referenced herein are incorporated by reference.

We claim:

1. A jet fuel synthesis plant, comprising:
a first CO₂ rich feed supplying CO₂ to said plant, a first H₂ rich feed supplying H₂ to said plant, or a first syngas feed combining the first CO₂ rich feed and the first H₂ rich feed; or a second syngas feed supplying a carbon oxide and hydrogen to said plant;
a methanol synthesis unit, arranged to receive the first CO₂ rich feed and the first H₂ rich feed, or arranged to receive the first syngas feed, or arranged to receive the second syngas feed, and provide an effluent stream comprising methanol;
a methanol-to-jet fuel synthesis section, arranged to receive at least a portion of the effluent stream comprising methanol, and provide a raw product containing hydrocarbons boiling in the jet fuel range;
said MTJ synthesis section being arranged to provide a by-product stream rich in paraffins and/or olefins;
said jet fuel synthesis plant further comprising a reforming system for reforming said by-product stream rich in paraffins and/or olefins, said reforming system comprising: a first reforming feed stream as said by-product stream rich in paraffins and/or olefins; a reforming unit (reformer) arranged to receive the by-product stream rich in paraffins and/or olefins, and carry out a steam reforming step, and provide a reformer-based syngas stream;
said jet fuel synthesis plant further being arranged to feed at least a portion of said reformer-based syngas stream to the inlet of the methanol synthesis unit;
wherein said jet fuel synthesis plant does not comprise a reforming unit arranged upstream of the methanol synthesis unit for providing said first or second syngas feed.

2. The jet fuel synthesis plant according to claim 1, wherein the reformer in the reforming system is any of a: steam methane reformer (SMR) i.e. tubular reformer, electrical steam methane reformer (e-SMR), autothermal reformer (ATR), convection heated reformer, and combinations thereof;
or wherein the reformer in the reforming system is:
an electrical steam methane reformer (e-SMR), which is arranged alone or together with an upstream pre-reformer;
or wherein the reformer in the reforming system is:
an autothermal reformer (ATR), which is arranged alone or together with an upstream pre-reformer.

3. The jet fuel synthesis plant according to claim 1, wherein said reforming system is further arranged for said first reforming feed stream being less than 15 wt % of said raw product containing hydrocarbons boiling in the jet fuel range, or less than 15 wt % of said jet fuel product stream.

4. The jet fuel synthesis plant according to claim 1, further comprising:
an electrolysis section comprising:
an electrolysis unit arranged to receive a water feedstock, and provide a second H₂ rich feed comprising H₂; and/or
an electrolysis unit arranged to receive a second CO₂ rich feed, or said first CO₂ rich feed comprising CO₂, or a portion thereof, and provide a CO-enriched feed;
wherein the electrolysis section is configured to combine the first or second H₂ rich feed comprising H₂ with the CO-enriched feed, and provide said second syngas feed;
or
a thermal decomposition unit arranged to receive a biomass feedstock to provide a crude syngas feed, and a crude syngas purification section arranged to receive the crude syngas feed and to provide said second syngas feed;
or
a reverse water gas shift unit arranged to receive a portion of said first CO₂ rich feed comprising CO₂ and a portion of said first H₂ rich feed comprising H₂, to provide a rWGS syngas feed; wherein the rWGS units is configured to combine the rWGS syngas feed with the remaining portion of: said first CO₂ rich feed comprising CO₂ and said first H₂ rich feed comprising H₂, and provide said second syngas feed.

5. The jet fuel synthesis plant according to claim 6, wherein the rWGS is also arranged to receive a portion of said by-product stream rich in paraffins and/or olefins.

6. The jet fuel synthesis plant according to claim 1, wherein the at least a portion of said reformer-based syngas stream is arranged to be fed to the inlet of the methanol synthesis unit in admixture with said CO₂ rich feed and/or said H₂ rich feed, or in admixture with said first syngas feed, or in admixture with said second syngas feed.

7. The jet fuel synthesis plant according to claim 1, wherein a methanol storage tank is arranged between said methanol synthesis unit and said MTJ synthesis section for storing at least a portion of the effluent stream comprising methanol.

8. The jet fuel synthesis plant of claim 1, where the methanol synthesis unit is arranged for the reformer-based syngas stream being up to up to 50% by volume basis of the inlet of the methanol synthesis unit.

9. The jet fuel synthesis plant according to claim 1, wherein the MTJ synthesis section comprises a methanol-to-olefin reactor to provide an olefin stream, an oligomerisation reactor (OLI reactor) to provide an oligomerised raw product stream, and a hydroprocessing reactor to provide the raw product containing hydrocarbons boiling in the jet fuel range.

10. The jet fuel synthesis plant according to claim 1, wherein the MTJ synthesis section comprises a methanol-to-olefin reactor (MTO reactor) to provide an olefin stream, an oligomerisation reactor (OLI reactor) to provide an oligomerised raw product stream, and a hydrogenation reactor (HYDRO reactor) to provide the raw product containing hydrocarbons boiling in the jet fuel range; and wherein the MTJ synthesis section further comprises:
a separator between the OLI reactor and HYDRO reactor, which is arranged to receive at least a portion of the oligomerised raw product stream and separate therefrom at least a portion of said by-product stream rich in paraffins and/or olefins;
and/or
a separator downstream the HYDRO reactor which is arranged to receive at least a portion of the raw product containing hydrocarbons boiling in the jet fuel range, and separate therefrom at least a portion of said by-product stream rich in paraffins and/or olefins.

11. The jet fuel synthesis plant according to claim 1, wherein the MTO reactor of the MTJ section of the plant is provided with a conversion catalyst comprising a zeolite with a framework having a 10-ring pore structure, said 10-ring pore structure being a unidimensional (1D) pore structure; said 1D pore structure being any of “MRE (ZSE-48), MTT (ZSM-23), TON (ZSM-22), or combinations thereof.

12. The jet fuel synthesis plant according to claim 1, wherein the by-product stream rich in paraffins and/or olefins, is a stream comprising at least 50% paraffins including n- and i-paraffins, and/or olefins; or wherein the by-product stream rich in paraffins and/or olefins, is a stream comprising at least 50 wt % olefins.

13. The jet fuel synthesis plant of claim 1, further arranged to provide one or more off-gas streams said one or more off-gas streams being one or more waste-gas streams rich in CO₂, H₂, CH₄, and wherein said reforming system is arranged to receive at least a portion of said one or more off-gas stream(s).

14. The jet fuel synthesis plant according to claim 1, wherein the methanol synthesis unit is arranged to provide an excess hydrogen stream;
wherein the MTJ synthesis section comprises a methanol-to-olefin reactor (MTO reactor), an olefin reactor (OLI reactor) and a hydrogenation reactor (HYDRO reactor); and wherein said HYDRO reactor is arranged to receive a portion of the first or second H₂ rich feed comprising H₂; and/or at least a portion of said excess hydrogen stream from the methanol synthesis unit;
and/or
wherein said optional upgrading section comprises a HCR reactor and the HCR reactor is arranged to receive: a portion of the first or second H₂ rich feed comprising H₂, and/or at least a portion of said excess hydrogen stream from the methanol synthesis unit;
and/or
wherein said reforming system is arranged to receive at least a portion of said excess hydrogen stream from the methanol synthesis unit.

15. A process for jet fuel synthesis of a first CO₂ rich feed comprising CO₂, and a first H₂ rich feed comprising H₂, or of a first syngas feed which combines said first CO₂ rich feed and said first H₂ rich feed; or of a second syngas feed comprising a carbon oxide and hydrogen, said process comprising the steps of:
providing a jet fuel synthesis plant, according to claim 16;
supplying CO₂ rich feed and H₂ rich feed, or said first syngas feed; or said second syngas feed, to the methanol synthesis unit, and providing an effluent stream comprising methanol;
supplying at least a portion of the effluent stream comprising methanol from the methanol synthesis unit to the methanol-to-jet fuel synthesis section, and providing a raw product containing hydrocarbons boiling in the jet fuel range;
supplying at least a portion of the raw product from the MTJ synthesis section to optional said upgrading section, and providing a jet fuel product stream; said options upgrading section comprising: a hydrocracking (HCR) reactor and/or a fractionation unit, thereby providing said jet fuel product stream;
withdrawing from the MTJ synthesis section and/or the optional-upgrading section a by-product stream rich in paraffins and/or olefins;
supplying at least a portion of a first reforming feed stream as said by-product stream rich in paraffins and/or olefins, to reforming system, performing a reforming step in reforming unit (reformer), and providing a reformer-based syngas stream;
supplying at least a portion of said reformer-based syngas stream to the inlet of the methanol synthesis unit, in admixture with said CO₂ rich feed and/or said H₂ rich feed, or in admixture with said first syngas feed; or in admixture with said second syngas feed;
wherein the process does not comprise steam reforming of a hydrocarbon feed gas for providing said first or said second syngas feed.

16. The plant of claim 1 comprising an upgrading section arranged to receive at least a portion of the raw product from the MTJ synthesis section, and provide a jet fuel product stream; said optional upgrading section comprising: a hydrocracking (HCR) reactor and/or a fractionation unit, thereby providing said jet fuel product stream; said optional upgrading section being arranged to provide a by-product stream rich in paraffins and/or olefins.

17. The plant of claim 4, wherein the electrolysis unit is arranged to provide the second H₂ rich feed comprising H₂, or a portion thereof, as as said first H₂ rich feed

18. The plant of claim 14, wherein said reforming system comprises a hydrogenation section, and wherein said hydrogenation section is arranged to receive said excess hydrogen stream.

19. The process of claim 15 comprising withdrawing from the MTJ synthesis section and/or the upgrading section one or more off-gas streams.

20. The process of claim 19, wherein said one or more off-gas streams comprise a second stream from the methanol synthesis unit and/or a second stream from the upgrading section.

21. The process of claim 15, wherein said by-product stream rich in paraffins and/or olefins comprises at least a portion of said one or more off-gas streams.
